(19) United States
(12) Patent Application Publication
(10) Pub. No.: US 2014/0211647 A1
(43) Pub. Date: Jul. 31, 2014

(54) METHOD AND APPARATUS OF SMALL CELL ENHANCEMENT IN A WIRELESS COMMUNICATION SYSTEM

(71) Applicant: INNOVATIVE SONIC CORPORATION, TAIPEI CITY (TW)

(72) Inventor: Ming-Che Li, Taipei City (TW)

(73) Assignee: INNOVATIVE SONIC CORPORATION, TAIPEI CITY (TW)

(21) Appl. No.: 14/165,998

(22) Filed: Jan. 28, 2014

Related U.S. Application Data
(60) Provisional application No. 61/757,400, filed on Jan. 28, 2013.

(51) Int. Cl. H04W 24/10

(52) U.S. Cl. CPC H04W 24/10
USPC 370/252

(57) ABSTRACT

Methods and apparatuses are disclosed for small cell enhancement in a wireless communication system. The method includes having a user equipment (UE) configured with at least a first serving cell and a second serving cell. The method also includes the UE reporting a power information report to the first serving cell, in which the power information report includes power information of a first set of serving cells and a second set of serving cells.

### CROSS-REFERENCE TO RELATED APPLICATIONS

The present Application claims the benefit of U.S. Provisional Patent Application Ser. No. 61/757,400 filed on Jan. 28, 2013, the entire disclosure of which is incorporated herein by reference.

### FIELD

This disclosure generally relates to wireless communication networks, and more particularly, to methods and apparatuses for small cell enhancement in a wireless communication system.

### BACKGROUND

With the rapid rise in demand for communication of large amounts of data to and from mobile communication devices, traditional mobile voice communication networks are evolving into networks that communicate with Internet Protocol (IP) data packets. Such IP data packet communication can provide users of mobile communication devices with voice over IP, multimedia, multicast and on-demand communication services.

An exemplary network structure for which standardization is currently taking place is an Evolved Universal Terrestrial Radio Access Network (E-UTRAN). The E-UTRAN system can provide high data throughput in order to realize the above-noted voice over IP and multimedia services. The E-UTRAN system's standardization work is currently being performed by the 3GPP standards organization. Accordingly, changes to the current body of 3GPP standard are currently being submitted and considered to evolve and finalize the 3GPP standard.

### SUMMARY

Methods and apparatuses are disclosed for small cell enhancement in a wireless communication system. The method includes having a user equipment (UE) configured with at least a first serving cell and a second serving cell. The method also includes the UE reporting a power information report to the first serving cell, in which the power information report includes power information from a first set of serving cells and a second set of serving cells.

### BRIEF DESCRIPTION OF THE DRAWINGS

FIG. 1 shows a diagram of a wireless communication system according to one exemplary embodiment.

FIG. 2 is a block diagram of a transmitter system (also known as access network) and a receiver system (also known as user equipment or UE) according to one exemplary embodiment.

FIG. 3 is a functional block diagram of a communication system according to one exemplary embodiment.

FIG. 4 is a functional block diagram of the program code of FIG. 3 according to one exemplary embodiment.

### DETAILED DESCRIPTION

The exemplary wireless communication systems and devices described below employ a wireless communication system, supporting a broadcast service. Wireless communication systems are widely deployed to provide various types of communication such as voice, data, and so on. These systems may be based on code division multiple access (CDMA), time division multiple access (TDMA), orthogonal frequency division multiple access (OFDMA), 3GPP LTE (Long Term Evolution) wireless access, 3GPP LTE-A or LTE-Advanced (Long Term Evolution Advanced), 3GPP2 UMB (Ultra Mobile Broadband), WiMax, or some other modulation techniques.

In particular, the exemplary wireless communication systems devices described below may be designed to support one or more standards such as the standard offered by a consortium named “3rd Generation Partnership Project” referred to herein as 3GPP, including Document Nos. RP-122032, “New Study Item Proposal for Small Cell Enhancements for E-UTRA and E-UTRAN—Physical-layer Aspects”, R1-130566, “Physical layer aspects of dual connectivity”, R1-130409, “Physical Layer Design for Dual Connectivity”. The standards and documents listed above are hereby expressly incorporated by reference in their entirety.

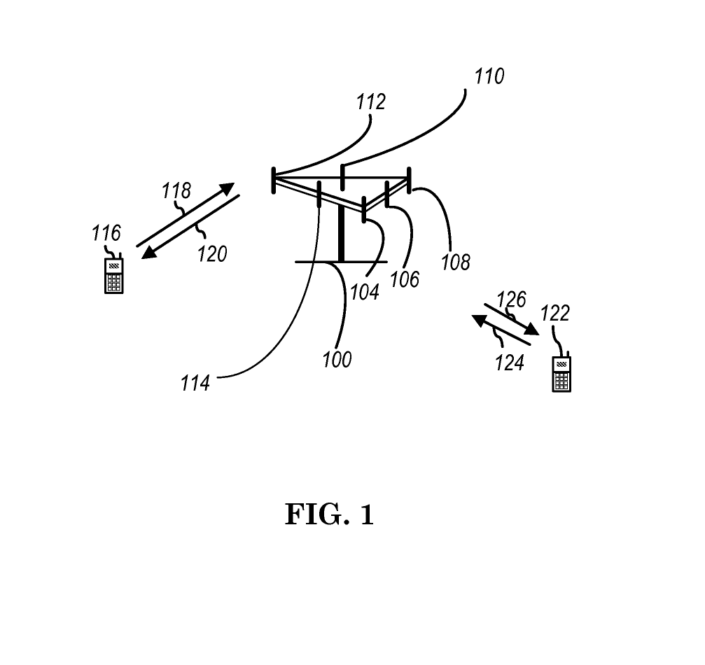

FIG. 1 shows a multiple access wireless communication system according to one embodiment of the invention. An access network 100 (AN) includes multiple antenna groups, one including 104 and 106, another including 108 and 110, and an additional including 112 and 114. In FIG. 1, only two antennas are shown for each antenna group, however, more or fewer antennas may be utilized for each antenna group. Access terminal 116 (AT) is in communication with antennas 112 and 114, where antennas 112 and 114 transmit information to access terminal 116 over forward link 120 and receive information from access terminal 116 over reverse link 118. Access terminal (AT) 122 is in communication with antennas 106 and 108, where antennas 106 and 108 transmit information to access terminal (AT) 122 over forward link 126 and receive information from access terminal (AT) 122 over reverse link 124. In a FDD system, communication links 118, 120, 124 and 126 may use different frequency for communication. For example, forward link 120 may use a different frequency then that used by reverse link 118.

Each group of antennas and/or the area in which they are designed to communicate is often referred to as a sector of the access network. In the embodiment, antenna groups each are designed to communicate to access terminals in a sector of the areas covered by access network 100.

In communication over forward links 120 and 126, the transmitting antennas of access network 100 may utilize beamforming in order to improve the signal-to-noise ratio of forward links for the different access terminals 116 and 122. Also, an access network using beamforming to transmit to access terminals scattered randomly through its coverage causes less interference to access terminals in neighboring cells than an access network transmitting through a single antenna to all its access terminals.

An access network (AN) may be a fixed station or base station used for communicating with the terminals and may also be referred to as an access point, a Node B, a base station, an enhanced base station, an eNB, or some other terminology. An access terminal (AT) may also be called user equipment (UE), a wireless communication device, terminal, access terminal or some other terminology.

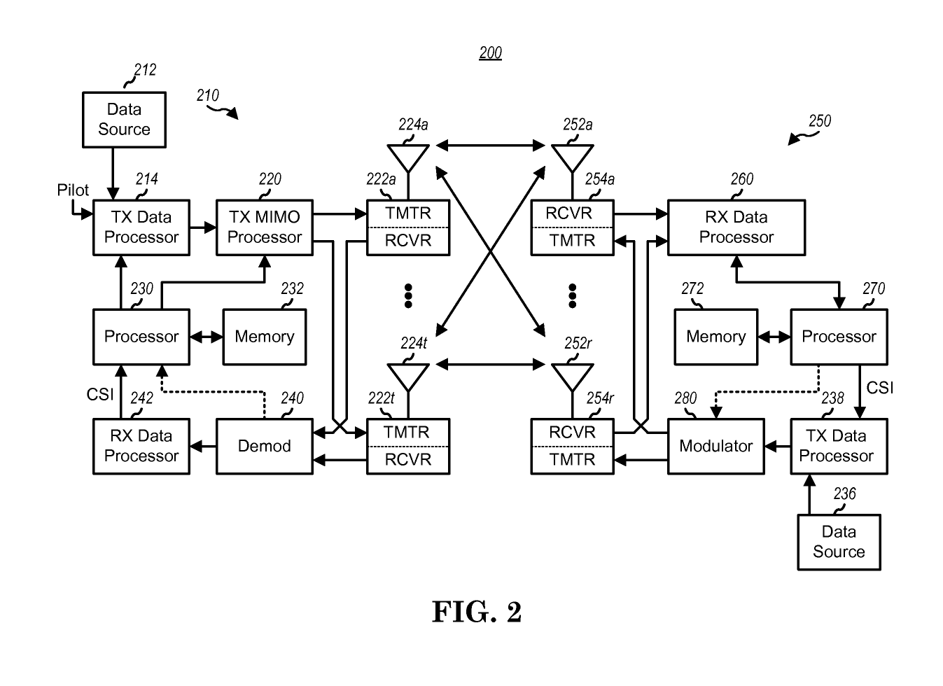

FIG. 2 is a simplified block diagram of an embodiment of a transmitter system 210 (also known as the access network) and a receiver system 250 (also known as access terminal (AT) or user equipment (UE)) in a MIMO system 200. At the transmitter system 210, traffic data for a number of data streams is provided from a data source 212 to a transmit (TX) data processor 214.

In one embodiment, each data stream is transmitted over a respective transmit antenna. TX data processor 214 formats, codes, and interleaves the traffic data for each data stream based on a particular coding scheme selected for that data stream to provide coded data.

The coded data for each data stream may be multiplexed with pilot data using OFDM techniques. The pilot data is typically a known data pattern that is processed in a known manner and may be used at the receiver system to estimate the channel response. The multiplexed pilot and coded data for each data stream is then modulated (i.e., symbol mapped) based on a particular modulation scheme (e.g., BPSK, QPSK, M-PSK, or M-QAM) selected for that data stream to provide modulation symbols. The data rate, coding, and modulation for each data stream may be determined by instructions performed by processor 230.

The modulation symbols for all data streams are then provided to a TX MIMO processor 220, which may further process the modulation symbols (e.g., for OFDM). TX MIMO processor 220 then provides N_{T} modulation symbol streams to N_{T} transmitters (TMTR) 222a through 222t. In certain embodiments, TX MIMO processor 220 applies beamforming weights to the symbols of the data streams and to the antenna from which the symbol is being transmitted.

Each transmitter 222 receives and processes a respective symbol stream to provide one or more analog signals, and further conditions (e.g., amplifies, filters, and upconverts) the analog signals to provide a modulated signal suitable for transmission over the MIMO channel. N_{T} modulated signals from transmitters 222a through 222t are then transmitted from N_{T} antennas 224a through 224t, respectively.

At receiver system 250, the transmitted modulated signals are received by N_{R} antennas 252a through 252r and the received signal from each antenna 252 is provided to a respective receiver (RCVR) 254a through 254r. Each receiver 254 conditions (e.g., filters, amplifies, and downconverts) a respective received signal, digitizes the conditioned signal to provide samples, and further processes the samples to provide a corresponding “received” symbol stream.

An RX data processor 260 then receives and processes the N_{R} received symbol streams from N_{R} receivers 254 based on a particular receiver processing technique to provide N_{T} “detected” symbol streams. The RX data processor 260 then demodulates, deinterleaves, and decodes each detected symbol stream to recover the traffic data for the data stream. The processing by RX data processor 260 is complementary to that performed by TX MIMO processor 220 and TX data processor 214 at transmitter system 210.

A processor 270 periodically determines which pre-coding matrix to use (discussed below). Processor 270 formulates a reverse link message comprising a matrix index portion and a rank value portion.

The reverse link message may comprise various types of information regarding the communication link and/or the received data stream. The reverse link message is then processed by a TX data processor 238, which also receives traffic data for a number of data streams from a data source 236, modulated by a modulator 280, conditioned by transmitters 254a through 254r, and transmitted back to transmitter system 210.

At transmitter system 210, the modulated signals from receiver system 250 are received by antennas 224, conditioned by receivers 222, demodulated by a demodulator 240, and processed by a RX data processor 242 to extract the reserve link message transmitted by the receiver system 250. Processor 230 then determines which pre-coding matrix to use for determining the beamforming weights then processes the extracted message.

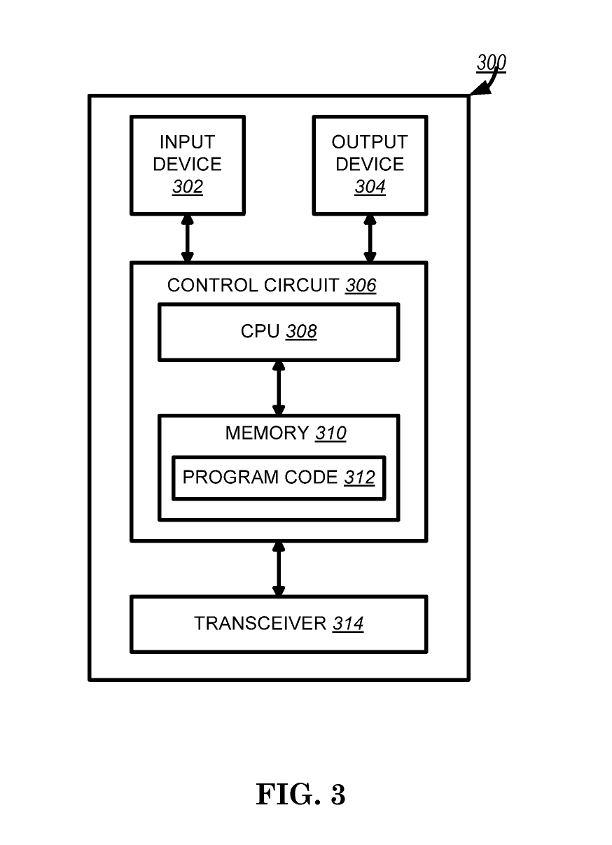

Turning to FIG. 3, this figure shows an alternative simplified functional block diagram of a communication device according to one embodiment of the invention. As shown in FIG. 3, the communication device 300 in a wireless communication system can be utilized for realizing the UEs (or ATs) 116 and 122 in FIG. 1, and the wireless communications system is preferably the LTE system. The communication device 300 may include an input device 302, an output device 304, a control circuit 306, a central processing unit (CPU) 308, a memory 310, a program code 312, and a transceiver 314. The control circuit 306 executes the program code 312 in the memory 310 through the CPU 308, thereby controlling an operation of the communications device 300. The communications device 300 can receive signals input by a user through the input device 302, such as a keyboard or keypad, and can output images and sounds through the output device 304, such as a monitor or speakers. The transceiver 314 is used to receive and transmit wireless signals, delivering received signals to the control circuit 306, and outputting signals generated by the control circuit 306 wirelessly.

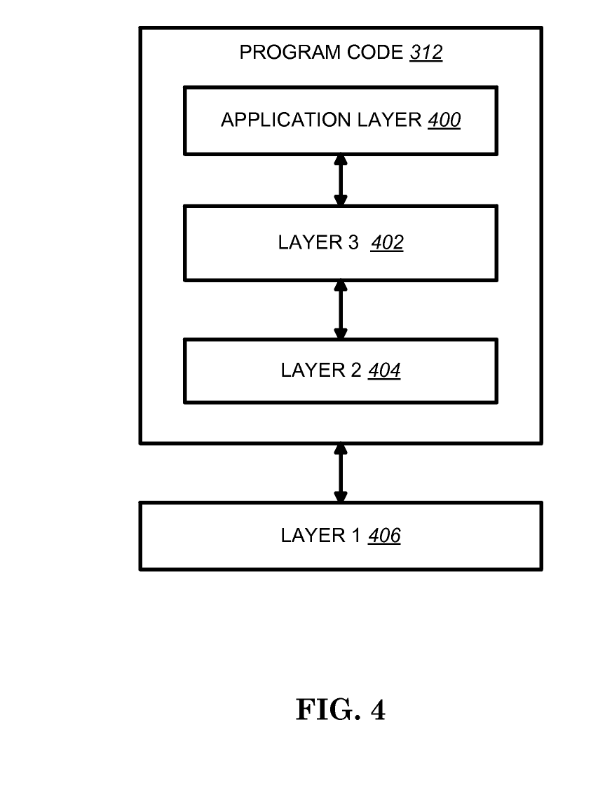

FIG. 4 is a simplified block diagram of the program code 312 shown in FIG. 3 in accordance with one embodiment of the invention. In this embodiment, the program code 312 includes an application layer 400, a Layer 3 portion 402, and a Layer 2 portion 404, and is coupled to a Layer 1 portion 406. The Layer 3 portion 402 generally performs radio resource control. The Layer 2 portion 404 generally performs link control. The Layer 1 portion 406 generally performs physical connections.

For LTE or LTE-A systems, the Layer 2 portion may include a Radio Link Control (RLC) layer and a Medium Access Control (MAC) layer. The Layer 3 portion may include a Radio Resource Control (RRC) layer.

In 3GPP RP-122032, a study of Small Cell Enhancements (SCE) for Evolved Universal Terrestrial Radio Access (E-UTRA) and Evolved Universal Terrestrial Radio Access Network (E-UTRAN) is described. A portion of the study is related to the benefits of mobility enhancements and dual connectivity to macro and small cell layers, and the scenarios in which such enhancements are feasible and beneficial.

In 3GPP R1-130566, it was proposed that a non-ideal backhaul scenario gives each point that an UE aggregate should, to as large extent as possible, act independent from other aggregated points on the physical layer and MAC layer.

In 3GPP R1-130409, it was proposed that an UE would need to transmit uplink (UL) control signals such as acknowledgement/negative acknowledgement (ACK/ NACK) and channel state information (CSI) information to the macro cell and small cell separately in the case of a non-ideal backhaul between the macro cell and small cells. Furthermore, it was proposed that the Physical Uplink Control Channel (PUCCH) resource may need to be configured for both the macro cell and small cells. In addition, 3GPP R1-130409 provides three motivations for dual connectivity to macro and small cell layers quoted as follows:
Motivation #1: Dual connectivity should be able to serve C-plane functionalities (connection management, mobility) using the macro cell layer
   To achieve better performance without a large amount of cell planning effort for deploying many small cells
Motivation #2: Dual connectivity should be able to select a U-plane data path via a macro, small cell, or both based on the required QoS including mobility performance
   Real time service, e.g., VoLTE, should be served by macro cells to avoid frequent interruption due to mobility between small cells
   Best effort services are served by small cells for higher user throughput performance
Motivation #3: Dual connectivity should be supported for a non-ideal backhaul between macro cell and small cell layers
   Note: Dual connectivity for an ideal backhaul can be supported in Rel-10 CA scenario 4

However, the 3GPP studies regarding SCE have shortcomings. For example, in a certain scenario, a macro cell and a small cell are controlled by different eNBs, in which the macro cell is controlled and scheduled by macro eNB, and the small cell may be controlled and scheduled by small eNB, pico eNB, or low power Node. When a UE has dual connectivity to the macro cell and the small cell at the same time, R1-130566 and R1-130409 disclose a preference that the macro and small cell resources be controlled and scheduled independently as much as possible. As a result, the UE would be scheduled separately per point/node/eNB. Also, the UE would report Hybrid Automatic Repeat Request (HARQ) and CSI separately per point/node/eNB. Although transmission scheduling can be operated separately, the total maximum transmit power is limited on the UE side. For the non-ideal backhaul scenario, it may not be possible for different eNBs to communicate dynamic transmission scheduling and allocate physical resources quickly. Thus, the information of UE transmit power cannot be delivered between different eNBs in time. Additionally, the total UE transmit power may possibly exceed the maximum more frequently, and the UE would need to apply power backoff/power scaling. As a result, the UL performance would be degraded.

According to the various embodiments disclosed herein, the UE reports power information of the macro cell layer(s) and small cell layers to a cell even though the macro cell layer(s) and small cell layers are operated independently by macro eNB and small eNB(s), thereby better handling or avoiding of exceeding of the total transmit power. In one embodiment, the transmitted power information is the Power Headroom Report (PHR).

In one embodiment a UE has dual connectivity to a macro cell and a small cell, and the macro cell and small cell are controlled by different eNBs. When the UE transmits the MAC control element corresponding to the PHR in the small cell, the MAC control element includes the power headroom of the macro and small cells. Since the information including some configured scheduling in the macro cell such as configured uplink grant or periodic CSI reporting can be pre-delivered to small eNB via the non-ideal backhaul between macro eNB and small eNB, the small eNB now knows the uplink timing occasions of the UE on the macro cell. With the reported power headroom of the macro cell, the small eNB reserves some power for the macro cell and can schedule the UE uplink transmission on the small cell with proper power.

When the UE transmits the MAC control element corresponding to the PHR in the macro cell, the MAC control element includes the power headroom of the macro cell. The power headroom of the small cell may not be included in the MAC control element since the small cell is mainly for data boost, and the scheduling of dynamic data transmission is hard to predict. Also, the transmission on macro cell may be considered to have higher priority than the transmission on small cell because of the C-plane and real time service. Furthermore, the cause of exceeding maximum transmit power may mainly come from macro cell since the uplink transmission power on macro cell is generally higher than the uplink transmission power on small cell.

On the other hand, when the total UE transmit power exceeds the maximum; the transmission on macro cell may be considered to have higher priority than the transmission on small cell. This means that the power scaling factor of the macro cell is larger than the power scaling factor of the small cell. It can also mean that no power scaling is applied to macro cell unless the power scaling factor of small cell is zero and total transmit power of the UE still would exceed maximum.

Accordingly, in one embodiment, the method includes configuring a user equipment (UE) with at least a first serving cell and a second serving cell. The method also includes the UE reporting a power information report to the first serving cell, in which the power information report includes power information of a first set of serving cells and a second set of serving cells.

In another embodiment, the method further includes reporting, by the UE, the power information report to a second serving cell, wherein the power information report includes the power information of the second set of serving cells. In one embodiment, in this method, the power information report does not include power information of the first set of serving cells. In another embodiment, the first set of serving cells includes the first serving cell, and the second set of serving cells includes the second serving cell.

In yet another embodiment, the first set of serving cells are small cells and the second set of serving cells are macro cells. In one embodiment, the first set of serving cells are macro cells and the second set of serving cells are small cells. In another embodiment, the small cells are controlled or scheduled by a small evolved Node B (eNB), lower power node, or pico Node. In another embodiment, the macro cells are controlled or scheduled by a macro evolved Node B (eNB).

In various embodiments, the power information is power headroom information. In other embodiments, the first and second serving cells are activated serving cells with configured uplink.

In another embodiment, the method includes configuring a user equipment (UE) with at least a first serving cell and a second serving cell. The method also includes setting a higher priority for a transmission on the second serving cell as compared to a transmission on the first serving cell when a total transmit power of the UE would exceed a total configured maximum power output.

In one embodiment, the higher priority of the transmission on the second serving cell means that the power scaling factor of the transmission on the second serving cell is larger than a power scaling factor of the transmission on the first serving cell. In one embodiment, the higher priority of the transmission on the second serving cell means that no power scaling is applied to the transmission on the second serving cell unless the power scaling factor of the transmission on the first serving cell is zero and the total transmit power of the UE still would exceed the total configured maximum output power.

In one embodiment, the second serving cell is a macro cell controlled by or scheduled by a macro evolved Node B (eNB). In another embodiment, the first serving cell is a small cell controlled or scheduled by a small evolved Node B (eNB), lower power node, or pico Node. In yet another embodiment, the transmission on the first serving cell or second serving cell is a Physical Uplink Shared Channel (PUSCH) transmission or a Physical Uplink Control Channel (PUCCH) transmission.

Referring back to FIGS. 3 and 4, the device 300 includes a program code 312 stored in memory 310. In one emodiment, the CPU 308 could execute program code 312 to execute one or more of the following: (i) to configure a user equipment (UE) with at least a first serving cell and a second serving cell, and (ii) to report, by the UE, a power information report to the first serving cell, in which the power information report includes power information from a first set of serving cells and a second set of serving cells.

In another embodiment, the CPU 308 could execute program code 312 to execute one or more of the following: (i) to configure a user equipment (UE) with at least a first serving cell and a second serving cell, and (ii) to set a higher priority for a transmission on the second serving cell as compared to a transmission on the first serving cell when a total transmit power of the UE would exceed a total configured maximum power output.

In addition, the CPU 308 can execute the program code 312 to perform all of the above-described actions and steps or others described herein.

Various aspects of the disclosure have been described above. It should be apparent that the teachings herein may be embodied in a wide variety of forms and that any specific structure, function, or both being disclosed herein is merely representative. Based on the teachings herein one skilled in the art should appreciate that an aspect disclosed herein may be implemented independently of any other aspects and that two or more of these aspects may be combined in various ways. For example, an apparatus may be implemented or a method may be practiced using any number of the aspects set forth herein. In addition, such an apparatus may be implemented or such a method may be practiced using other structure, functionality, or structure and functionality in addition to or other than one or more of the aspects set forth herein. As an example of some of the above concepts, in some aspects concurrent channels may be established based on pulse repetition frequencies. In some aspects concurrent channels may be established based on pulse position or offsets. In some aspects concurrent channels may be established based on time hopping sequences. In some aspects concurrent channels may be established based on pulse repetition frequencies, pulse positions or offsets, and time hopping sequences.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of skill would further appreciate that the various illustrative logical blocks, modules, processors, means, circuits, and algorithm steps described in connection with the aspects disclosed herein may be implemented as electronic hardware (e.g., a digital implementation, an analog implementation, or a combination of the two, which may be designed using source coding or some other technique), various forms of program or design code incorporating instructions (which may be referred to herein, for convenience, as “software” or a “software module”), or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

In addition, the various illustrative logical blocks, modules, and circuits described in connection with the aspects disclosed herein may be implemented within or performed by an integrated circuit (“IC”), an access terminal, or an access point. The IC may comprise a general purpose processor, a digital signal processor (DSP), an application specific integrated circuit (ASIC), a field programmable gate array (FPGA) or other programmable logic device, discrete gate or transistor logic, discrete hardware components, electrical components, optical components, mechanical components, or any combination thereof designed to perform the functions described herein, and may execute codes or instructions that reside within the IC, outside of the IC, or both. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

It is understood that any specific order or hierarchy of steps in any disclosed process is an example of a sample approach. Based upon design preferences, it is understood that the specific order or hierarchy of steps in the processes may be rearranged while remaining within the scope of the present disclosure. The accompanying method claims present elements of the various steps in a sample order, and are not meant to be limited to the specific order or hierarchy presented.

The steps of a method or algorithm described in connection with the aspects disclosed herein may be embodied directly in hardware, in a software module executed by a processor, or in a combination of the two. A software module (e.g., including executable instructions and related data) and other data may reside in a data memory such as RAM memory, flash memory, ROM memory, EPROM memory, EEPROM memory, registers, a hard disk, a removable disk, a CD-ROM, or any other form of computer-readable storage medium known in the art. A sample storage medium may be coupled to a machine such as, for example, a computer/processor (which may be referred to herein, for convenience, as a “processor”) such the processor can read information (e.g., code) from and write information to the storage medium. A sample storage medium may be integral to the processor. The processor and the storage medium may reside in an ASIC. The ASIC may reside in user equipment. In the alternative, the processor and the storage medium may reside as discrete components in user equipment. Moreover, in some aspects any suitable computer-program product may comprise a computer-readable medium comprising codes relating to one or more of the aspects of the disclosure. In some aspects a computer program product may comprise packaging materials.

While the invention has been described in connection with various aspects, it will be understood that the invention is capable of further modifications. This application is intended to cover any variations, uses or adaptation of the invention following, in general, the principles of the invention, and including such departures from the present disclosure as come within the known and customary practice within the art to which the invention pertains.

1. A method for small cell enhancement in a wireless communication system, the method comprising:
having a user equipment (UE) configured with at least a first serving cell and a second serving cell; and
reporting, by the UE, a power information report to the first serving cell, wherein the power information report includes power information of a first set of serving cells and a second set of serving cells.

2. The method of claim 1, further comprising: reporting, by the UE, the power information report to a second serving cell, wherein the power information report includes the power information of the second set of serving cells.

3. The method of claim 2, wherein the power information report does not include power information from the first set of serving cells.

4. The method of claim 1, wherein the first set of serving cells includes the first serving cell, and wherein the second set of serving cells includes the second serving cell.

5. The method of claim 1, wherein the first set of serving cells are small cells and the second set of serving cells are macro cells.

6. The method of claim 1, wherein the first set of serving cells are macro cells and the second set of serving cells are small cells.

7. The method of claim 5, wherein the small cells are controlled or scheduled by a small evolved Node B (eNB), lower power node, or pico Node.

8. The method of claim 5, wherein the macro cells are controlled or scheduled by a macro evolved Node B (eNB).

9. The method of claim 1, wherein the power information is power headroom information.

10. The method of claim 1, wherein the first and second serving cells are activated serving cells with configured uplink.

11. A method for small cell enhancement in a wireless communication system, the method comprising:
having a user equipment (UE) configured with at least a first serving cell and a second serving cell; and
setting a higher priority for a transmission on the second serving cell as compared to a transmission on the first serving cell when a total transmit power of the UE would exceed a total configured maximum power output.

12. The method of claim 11, wherein the higher priority of the transmission on the second serving cell means that a power scaling factor of the transmission on the second serving cell is larger than a power scaling factor of the transmission on the first serving cell.

13. The method of claim 11, wherein the higher priority of the transmission on the second serving cell means that no power scaling is applied to the transmission on the second serving cell unless the power scaling factor of the transmission on the first serving cell is zero and the total transmit power of the UE still would exceed the total configured maximum output power.

14. The method of claim 11, wherein the second serving cell is a macro cell controlled by or scheduled by a macro evolved Node B (eNB).

15. The method of claim 11, wherein the first serving cell is a small cell controlled or scheduled by a small evolved Node B (eNB), lower power node, or pico Node.

16. The method of claim 11, wherein the transmission on the first serving cell or second serving cell is a Physical Uplink Shared Channel (PUSCH) transmission or a Physical Uplink Control Channel (PUCCH) transmission.

17. A communication device for improving a new carrier type in a wireless communication system, the communication device comprising:
a control circuit;
a processor installed in the control circuit;
a memory installed in the control circuit and operatively coupled to the processor;
wherein the processor is configured to execute a program code stored in memory to provide small cell enhancement in a wireless communication system by:
having a user equipment (UE) configured with at least a first serving cell and a second serving cell; and
reporting, by the UE, a power information report to the first serving cell, wherein the power information report includes power information of a first set of serving cells and a second set of serving cells.

18. The communication device of claim 17, wherein the program code is further configured to report, by the UE, the power information report to a second serving cell, wherein the power information report includes the power information of the second set of serving cells.

19. The communication device of claim 17, wherein the first set of serving cells are small cells and the second set of serving cells are macro cells.

20. The communication device of claim 17, wherein the first set of serving cells are macro cells and the second set of serving cells are small cells.
